(19) United States
(12) Patent Application Publication
(10) Pub. No.: US 2002/0054134 A1
(43) Pub. Date: May 9, 2002

(54) Method and apparatus for providing streaming media in a communication network

(76) Inventor: Brett R. Kelts, Newport Beach, CA (US)

Correspondence Address: TERRANCE A. MEADOR, GRAY CARY WARE & FREIDENRICH, LLP, 4365 EXECUTIVE DRIVE, SUITE 1100, SAN DIEGO, CA, 92121-2133, US

(21) Appl. No.: 09/747,075

(22) Filed: Dec. 22, 2000

Related U.S. Application Data
(60) Provisional application No. 60/195,955, filed on Apr. 10, 2000.

(51) Int. Cl. G09G 5/00

(52) U.S. Cl. 345/788; 345/700

(57) ABSTRACT

A navigation interface display system generates a navigation map that organizes a plurality of information sources in an easy-to-use manner. In practical embodiments, the information sources are online music, video, or other streaming media content providers. The navigation map employs a hierarchical display protocol for a plurality of map items that serve as links to the various content sources. In addition, the map items are displayed on distinctive areas or features of the map, where such features represent different programming/content genres, categories, subgenres, or subcategories. The navigation interface display system is deployed in a layered architecture with centralized servers, centralized databases related to the map data and the content data, and different presentation layer interfaces associated with different presentation or display devices. The layered architecture allows a single deployment of the display system to service multiple users, where each user can utilize any number of different presentation devices.

### CROSS REFERENCE TO RELATED APPLICATIONS

This application claims priority of U.S. provisional patent application serial No. 60/195,955, titled “Method and Apparatus for Providing Streaming Media in a Communication Network,” filed Apr. 10, 2000. This application is related to U.S. patent application Ser. No. ______, titled “Interactive Display Interface for Information Objects,” filed ______, and to U.S. patent application Ser. No. ______, titled “System and Method for Providing an Interactive Display Interface for Information Objects,” filed ______.

### FIELD OF THE INVENTION

The present invention relates generally to the processing of information provided via a communication system, a computer system, or other electronic equipment. More particularly, the present invention relates to a system for locating and identifying streaming media provided by a communication network.

### BACKGROUND OF THE INVENTION

The growing popularity of the Internet has resulted in the online accessibility of music, video, and application files. The Internet itself, and the World Wide Web in particular, allows a user to access an almost unlimited number of different web pages identified by a like number of unique uniform resource locators (URLs). Streaming media technology allows Internet users to remotely access a vast assortment of audio and video broadcasts, including movies, news programs, dramatic works, music, sports programs, talk shows, and other content. Instead of a relatively small number of traditional radio and television stations available in major metropolitan markets or via standard cable or satellite systems, Internet users are now presented with thousands of possibilities. Never before has there been such a vast selection of alternatives, with broadcasters providing every imaginable permutation for every conceivable area of interest, from mainstream popular music to the most obscure and unlikely niches.

End users of various presentation devices (e.g., personal computers and other Internet-enabled devices) often have difficulty searching, locating, viewing, and downloading suitable content due to the vast number of content files and/or content sources. For example, the large quantity of available Internet broadcasters (and other streaming media providers) presents a paradox: while users undoubtedly benefit from the unprecedented number of choices in genre and content which broadcasters provide, they cannot easily and efficiently select from among the hundreds of stations, channels, and/or entities broadcasting a given type of music, video, program, or file. In addition, users cannot identify what is interesting, relevant, or available, or determine the quality of service, bit rate, or other operational parameters of the available broadcasts.

Known solutions utilized by many Internet sites are based on the garden variety search engine interface. In one form of this interface, the user enters a search query (a word or a phrase) and is eventually presented with a multi-page list of hundreds or thousands of possible matches. Alternatively, the user may be shown a hierarchical list of categories, with each category serving as a higher level in the hierarchical display of relevant content. In this manner, the user can continue selecting links to navigate deeper into the hierarchy until he finds a suitable file or link.

One prior art system is implemented as a stand-alone software application that resides at the end user's computing device. This system utilizes a number of icons categorized together as a planet, where the icons represent links to different web pages or files stored on the computing device. This system maintains no connectivity between the user's computing device and any real-time data maintained by a remote server. Consequently, this system is not capable of providing current programming information related to broadcast content that is available to the end user.

Currently, there are many web sites that list subsets of available streaming media sources (such as Internet radio stations), but none which organize and display a large number or all of the available broadcasters. Some of these sites are broadcast technology specific, e.g., REAL.COM (providing RealAudio and RealVideo files), WINDOWSMEDIA.COM (providing WMA files), and SHOUTCAST.COM providing MP3 files). These sites only show lists of stations that employ the respective encoding technologies. Other sites may be dedicated to a group of servers or to a particular network, such as BROADCAST.COM, LIVE365.COM, LAUNCH.COM, and others. Unfortunately, such sites only display stations being broadcast by their captive servers, and it is not in their best interests to enable users to access other competing web sites. Some web sites, such as MP3.COM and SCOUR.COM have attempted to create “streaming media portals.” However, their diffuse focus includes the downloading of MP3 files from obscure bands, providing movie trailers, providing news commentary snippets, and the like. None of these sites address the unique problems faced by Internet users. The primary problem with all of these sites is that they offer only a relatively small subset of available Internet content.

A number of hardware vendors, such as Kerbango and SonicBox, manufacture devices that resemble conventional stereo equipment. These devices communicate with the Internet to allow users to hear Internet radio in the absence of a computer system. The respective web sites also offer a software interface that emulates the hardware device's functionality on a personal computer. While the virtual tuner idea is attractive on the surface (in that it gives users an interface they are already comfortable with), closer examination reveals several shortcomings. For example, the familiarity associated with the look of a radio template is overshadowed by the host of deficiencies introduced by an interface modeled after a 1920s-era gadget. A radio interface is a marvelous compromise solution designed to address the realities and limitations of physical airspace (where only a few dozen discrete stations are available in any given location); however, it is not a particularly effective way to interface with virtual airspace, and it is a terrible way to display large amounts of disparate data.

A handful of software tuner applications are currently available. One relatively full-featured application is RADIOSPY, available from GAMESPY INDUSTRIES, INC. This application displays available broadcast sites with the station information presented to the user in a long, alphanumeric list format. With over 5,000 stations listed on the interface, the sheer volume of data is overwhelming, and as more sites come online it will become increasingly impractical to use. Other software tuners include INTERNET MEDIA PLAYER, available from MIDISOFT, which integrates a custom media player with a very limited list of available broadcasters via a menu system. Unfortunately, this application includes the deficiencies of both the radio-like interface and the listing format. A common problem with these software tuners is that the interfaces do not provide a logical, efficient, or easy-to-comprehend method for displaying large amounts of data. Thus, they fail to achieve their core objective of showing the user what content is currently available. In addition, the downloading, installing, and configuring of the software applications can create a significant implementation barrier for many computer users.

Accordingly, there is a need in the industry for an effective and intuitive system for locating and identifying media and other content, which may be provided by multiple information sources and service providers, via a communication network.

### BRIEF SUMMARY OF THE INVENTION

The present invention provides a system for generating an interactive navigation interface for display at an end user device. In accordance with a preferred embodiment, the end user device merely functions as a display or playback component; the navigation interface itself is generated, maintained, and processed by one or more remote server components. The navigation interface is configured to allow a user to intuitively, effectively, and easily determine the broadcast status associated with a large number of content providers, channels, stations, web sites, or the like. In a particular implementation, the navigation interface is designed for use in connection with a streaming media portal site. The navigation interface utilizes a magnification (zoom) feature along with a hierarchical protocol for the display of active map items representing different streaming media sources or content. In this respect, the navigation interface displays only a limited number of active map items at an initial magnification level and introduces additional active map items as the magnification changes. The interactive navigation interface may include a number of additional features designed to enhance the display of useful information to the user and to make it easier for the user to view and locate appropriate content, such as streaming media files.

In accordance with another aspect of the present invention, the navigation interface system is configured in a layered architecture. In this manner, the system can be deployed in a centralized mode using remote servers. Various presentation layers associated with different presentation devices are utilized to obtain generic display characteristic data from the remote servers. In turn, the respective presentation layers act as an interface between the generic data and data formatted for compatibility with the presentation devices. Consequently, the system need not employ customized server applications for the different presentation devices.

### BRIEF DESCRIPTION OF THE DRAWINGS

A more complete understanding of the present invention may be derived by referring to the detailed description and claims when considered in conjunction with the following Figures, wherein like reference numbers refer to similar elements throughout the Figures.

FIG. 1 is a block diagram of one embodiment of a network system according to the present invention;

FIG. 2 is a block diagram of an example computer system suitable for use in the system shown in FIG. 1;

FIG. 3 is a schematic representation of one embodiment of a layout of a graphical user interface provided in accordance with the principles of the invention;

FIG. 4 is an example display screen configured in accordance with the present invention;

FIG. 5 illustrates one embodiment of a navigator bar used in the graphical user interface of the invention;

FIG. 6 is a schematic representation of a system architecture that implements the principles of the invention; and

FIG. 7 is a schematic representation of an exemplary navigation interface display.

### DETAILED DESCRIPTION OF A PREFERRED EMBODIMENT

The present invention may be described herein in terms of functional block components and various processing steps. It should be appreciated that such functional blocks may be realized by any number of hardware components configured to perform the specified functions. For example, the present invention may employ various integrated circuit components, e.g., memory elements, digital signal processing elements, logic elements, look-up tables, and the like, which may carry out a variety of functions under the control of one or more microprocessors or other control devices. In addition, those skilled in the art will appreciate that the present invention may be practiced in conjunction with any number of data transmission protocols and that the systems described herein are merely exemplary applications for the invention.

It should be appreciated that the particular implementations shown and described herein are illustrative of the invention and its best mode and are not intended to otherwise limit the scope of the invention in any way. Indeed, for the sake of brevity, conventional techniques for signal processing, data transmission, signaling, network control, and other functional aspects of the systems (and the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical embodiment.

One aspect of the present invention involves a software application and web site that offers directories of Internet radio stations, video channels, or other streaming media sources, while facilitating the ability for the user to conduct “one stop shopping” with an easy to read, graphical display of a vast number of available stations or channels, bandwidth information, and/or other germane data.

A second aspect of the present invention involves the identification of the effective bit rate of streaming media on a global computer network such as the Internet. Currently, the published or advertised bit rate of streaming media on the Internet may not always be reliable. In addition, the published bit rate doesn't always reflect the actual effective bit rate that end users will experience. Because the load on the various servers may vary throughout the day, it is virtually impossible to predict the reliability of a given network-based broadcasting station. With multiple intermediary servers between the user and broadcaster operating under varying loads, the user often experiences annoying breaks and skips in the broadcast, resulting in a diminished overall experience. To make the selection process even more arbitrary, many Internet stations do not broadcast 24 hours a day. Some go offline periodically due to server glitches, some are “full” (meaning all their bandwidth is taken), etc.

As web broadcasting increases in popularity, users will naturally require an easy-to-use mechanism for locating, filtering, and evaluating the status of available broadcasters. An ideal solution should meet the following criteria:

Present an interface that is fast, intuitive, and easy-to-use;

Organize stations by broadcast genre;

Suggest other stations that the user might enjoy;

Identify stations broadcasting at a suitable bandwidth, e.g., fast enough to meet the user's minimum quality expectation, but not faster than the respective Internet connection will support;

Evaluate connections in real-time to assure that stations are broadcasting reliably and that traffic permits a steady connection; and

Work with most (if not all) available broadcast technologies, e.g., WMA, MP3, Real Audio, QuickTime, and any future media transmission protocol.

A third aspect of the present invention involves an apparatus and method for providing a user interface for selecting streaming media. Instead of taking a traditional hierarchical listing approach, the preferred embodiment of the present invention illustrates available sites using a graphical user interface that can be suitably formatted according to a number of different presentation devices. In one embodiment, the graphical user interface is rendered as a navigation map. This map may feature a mythical group of islands, continents, seas, and a number of map items or icons representing available streaming media broadcasters and content.

Different regions on the navigation map can be labeled to represent a different genre or category, with map items and/or broadcaster information located within the appropriate region. Logical sub-regions can represent subsets of a genre or subcategories for the content. For example, one massive island may be called “Talk Land,” and represent talk radio stations. One portion of the island can be dedicated to sports talk, another sub-region may focus on Christian talk, and so on.

The navigation map may be displayed with rolling hills, water, forests, deserts, and other terrain. Radio towers or other map item objects can be displayed as icons. In a preferred embodiment, the display is dynamic in nature such that it can reflect what is happening at the moment. In a practical embodiment, the appearance of the map items change based on advertised bandwidth, whether the stations are currently broadcasting, whether they are full, whether they are marked as “favorites”, and/or other criteria. The user can zoom-in and zoom-out, scroll to other portions of the map, click on a map item to find out more information about the station or channel, and access other related functions. The display will be “live” in that information displayed for a given station may change dynamically as the station's status changes. For example, if a station becomes “full”, the map item icon may change immediately to reflect the new status.

A streaming media portal according to the present invention is preferably configured as a completely web-based application; no additional software need be installed on the end user presentation system. When the end user selects the “Play” button to listen to a broadcast, the web site which implements the principles of the invention will launch the appropriate application already installed on the end user's system (e.g., Windows Media Player, QuickTime, Real Player, etc.).

Definitions

As discussed herein, a “computer system” is a product including circuitry capable of processing data. The computer system may include, but is not limited to, general purpose computer systems (e.g., server, laptop, desktop, palmtop, personal electronic devices, etc.), personal computers (PCs), hard copy equipment (e.g., printer, plotter, fax machine, etc.), banking equipment (e.g., an automated teller machine), and the like. Content refers to application programs, driver programs, utility programs, audio, video, and other files, payload, and combinations thereof, as well as graphics, informational material (articles, stock quotes, etc.), and the like, either singly or in any combination. A “communication link” refers to the medium or channel of communication. The communication link may include, but is not limited to, a telephone line, a modem connection, an Internet connection, an Integrated Services Digital Network (“ISDN”) connection, an Asynchronous Transfer Mode (ATM) connection, a frame relay connection, an Ethernet connection, a coaxial connection, a fiber optic connection, satellite connections (e.g. Digital Satellite Services, etc.), wireless connections, radio frequency (RF) links, electromagnetic links, two way paging connections, and combinations thereof.

System Overview

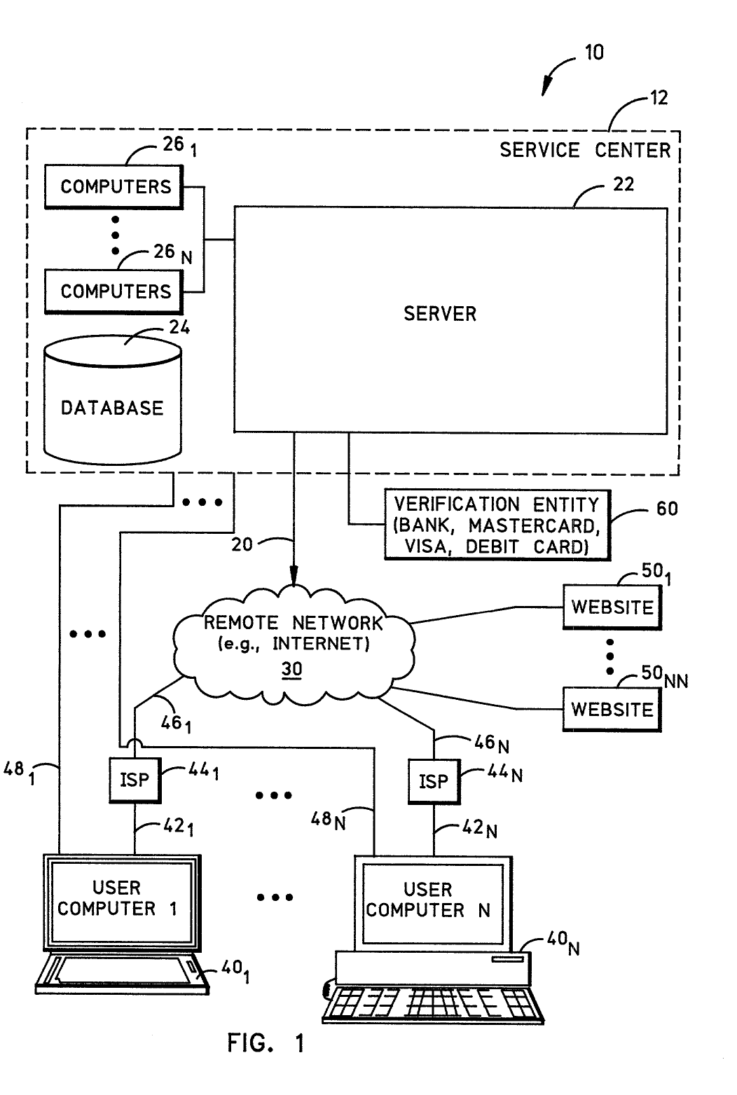

A description of an exemplary system, which incorporates embodiments of the present invention, is herein described. FIG. 1 shows a system block diagram of one embodiment of a network system 10 in which the system and methods of the invention are used. Referring to FIG. 1, the network system 10 comprises a service center 12 that is connected over one or more communication links 20 to a remote network 30 (e.g., a wide area network or the Internet) or a remote site (e.g., a satellite, which is not shown in FIG. 1) to one or more user computer systems 40₁-40_{N} (“40”). In one embodiment the service center 12 maintains or is otherwise associated with a web site. The service center 12 includes one or more servers 22 and one or more databases 24. As used herein, server 22 may refer to a single server or a plurality of cooperating servers. In one embodiment, the server 22 includes software modules for performing the processes of the invention, as described in detail in the following sections.

The server 22 may be coupled to one or more verification entities such as entity 60 for verification of credit information and for processing credit transactions. The service center 12 may also include one or more computers 26₁-26_{M}. If a plurality of computers are used, then the computers 26₁-26_{M} may be connected by a local area network (LAN) or any other similar connection technology. However, it is also possible for the service center 12 to have other configurations. For example, a smaller number of larger computers (i.e., a few mainframe, mini, or other computers) with a number of internal programs or processes running on the larger computers may be capable of establishing communication links to the user computers.

The remote network 30 or remote site allows the service center 12 to provide information and services to the user computers 40₁-4_{N}, using software that is stored at the service center 12. The one or more databases 24 connected to the service center computer(s), e.g., computer 26₁, are used to store data. Each user computer 40₁-40_{N} is connected over a corresponding communication link 42₁-42_{N} such as a local carrier exchange to a respective ISP 44₁-44_{N}, through which access to the remote network 30 is made. By inputting the URL address of the target web site with which the user desires to interact, the user may be connected to various web sites, such as web sites 50₁-50_{NN}. In an alternate embodiment, each user may be connected over a corresponding communication link 48₁-48_{N} to the service center 12, which provides Internet access and service to the user computer(s) 40. In a further embodiment, the display screen for viewing the graphical user interface of the invention may be located on a television coupled to the network 30. For example, the end user may be a viewer of a television that communicates with a set-top box or an equivalent control device. In this case, navigation through the graphical user interface of the invention may be provided through the use of control buttons on a remote control unit for controlling viewing of the television, or by other means known in the art.

One aspect of the present invention relates to the development of software and a graphical user interface for presenting, locating, and identifying streaming media provided on a web site. Such a development process may occur on a computer system that is separate and apart from the service center 12, or may be developed using one of the computers 26₁-26_{M}. Alternatively, the development process may occur on a computer that is not coupled to the communication network. Upon completion of the development process, the code may be stored in the database 24. Alternatively, the code may be stored on a machine-readable medium, such as a diskette, CD or DVD. In one embodiment, the service center 12 that is connected over one or more communication links to a remote network (such as the Internet) may be requested to provide the code for use on a client web site. In this embodiment, the code is stored on the database 24. Alternatively, the code may be provided on a machine-readable medium such as a diskette, a CD or DVD, for use by a client to enhance his/her web site.

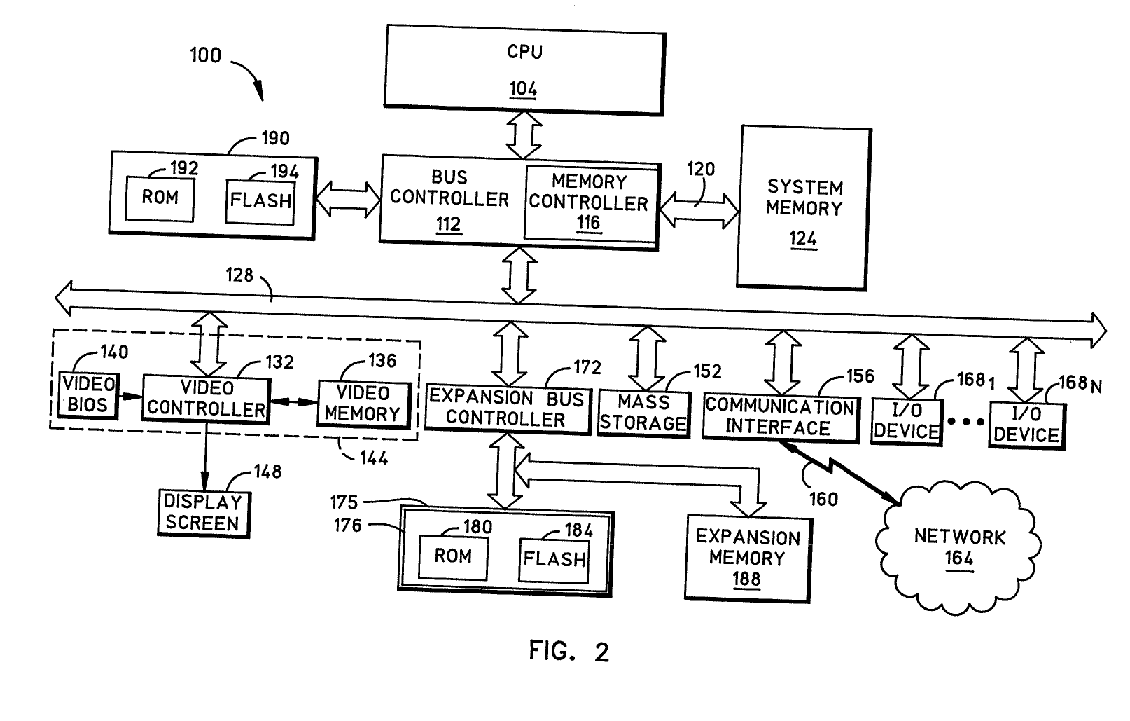

Referring to FIG. 2, the computer system 100 (representing either of computer 26 or 40) comprises a processor or a central processing unit (CPU) 104. The illustrated CPU 104 includes an Arithmetic Logic Unit (ALU) for performing computations, a collection of registers for temporary storage of data and instructions, and a control unit for controlling operation for the system 100. In one embodiment, the CPU 104 includes any one of the x86 or Pentium™ family of microprocessors as marketed by Intel™ Corporation, the K-6 microprocessor as marketed by AMD™, or the 6×86MX microprocessor as marketed by Cyrix™ Corporation. Further examples include the Alpha™ processor as marketed by Digital Equipment Corporation™, the 680X0 processor as marketed by Motorola™; or the Power PC™ processor as marketed by IBM™. In addition, any of a variety of other processors, including those from Sun Microsystems, MIPS, IBM, Motorola, NEC, Cyrix, AMD, Nexgen and others may be used for implementing CPU 104. The CPU 104 is not limited to a microprocessor but may take on other forms such as microcontrollers, digital signal processors, reduced instruction set computers (RISC), application specific integrated circuits, and the like. Although shown with one CPU 104, computer system 100 may alternatively include multiple processing units.

The CPU 104 is coupled to a bus controller 112 by way of a CPU bus. The bus controller 112 includes a memory controller 116 integrated therein, though the memory controller 116 may be external to the bus controller 112. The memory controller 116 provides an interface for access by the CPU 104 or other devices to system memory 124 via memory bus 120. In one embodiment, the system memory 124 includes synchronous dynamic random access memory (SDRAM). System memory 124 may optionally include any additional or alternative high speed memory device or memory circuitry. The bus controller 112 is coupled to a system bus 128 that may be a peripheral component interconnect (PCI) bus, Industry Standard Architecture (ISA) bus, etc. Coupled to the system bus 128 are a graphics controller, a graphics engine or a video controller 132, a mass storage device 152, a communication interface device 156, one or more input/output (I/O) devices 168₁-168_{N}, and an expansion bus controller 172. The video controller 132 is coupled to a video memory 136 (e.g., 8 Megabytes) and video BIOS 140, all of which may be integrated onto a single card or device, as designated by numeral 144. The video memory 136 is used to contain display data for displaying information on the display screen 148, and the video BIOS 140 includes code and video services for controlling the video controller 132. In another embodiment, the video controller 132 is coupled to the CPU 104 through an Advanced Graphics Port (AGP) bus.

The mass storage device 152 may include (but is not limited to) a hard disk, floppy disk, CD-ROM, DVD-ROM, tape, high density floppy, high capacity removable media, low capacity removable media, solid state memory device, etc., and combinations thereof. The mass storage device 152 may include any other mass storage medium. The communication interface device 156 may include a network card, a modem interface, or other device for accessing network 164 via communications link 160. The I/O devices 168₁-168_{N} may be realized as a keyboard, mouse, audio/sound card, printer, and the like. The I/O devices 168₁-168_{N} may be realized as a disk drive, such as a compact disk drive, a digital disk drive, a tape drive, a zip drive, a jazz drive, a digital video disk (DVD) drive, a magneto-optical disk drive, a high density floppy drive, a high capacity removable media drive, a low capacity media device, and/or any combination thereof. The expansion bus controller 172 is coupled to non-volatile memory 175, which includes system firmware 176. The system firmware 176 includes system BIOS, which is for controlling, among other things, hardware devices in the computer system 100. The system firmware 176 also includes ROM 180 and flash (or EEPROM) 184. The expansion bus controller 172 is also coupled to expansion memory 188 having RAM, ROM, and/or flash memory (not shown). The system 100 may additionally include a memory module 190 that is coupled to the bus controller 112. In one embodiment, the memory module 190 comprises a ROM 192 and flash (or EEPROM) 194.

As is familiar to those skilled in the art, the computer system 100 further includes an operating system (OS) and at least one application program, which in one embodiment, are loaded into system memory 124 from mass storage device 152 and launched after POST. The OS may include any type of OS including, but not limited or restricted to, DOS, Windows™ (e.g., Windows 95™, Windows 98™, Windows NT™), Unix, Linux, OS/2, OS/9, Xenix, etc. The operating system is a set of one or more programs which control the computer system's operation and the allocation of resources. The application program is a set of one or more software programs that performs a task desired by the user.

In accordance with the practices of persons skilled in the art of computer programming, the present invention is described below with reference to symbolic representations of operations that are performed by computer system 100, unless indicated otherwise. Such operations are sometimes referred to as being computer-executed. It will be appreciated that operations that are symbolically represented include the manipulation by CPU 104 of electrical signals representing data bits and the maintenance of data bits at memory locations in system memory 124, as well as other processing of signals. The memory locations where data bits are maintained are physical locations that have particular electrical, magnetic, optical, or organic properties corresponding to the data bits.

When implemented in software, the elements of the present invention are essentially the code segments to perform the necessary tasks. The program or code segments can be stored in a processor readable medium or transmitted by a computer data signal embodied in a carrier wave over a transmission medium or communication link. The “processor readable medium” or “machine-readable medium” may include any medium that can store or transfer information. Examples of the processor readable medium include an electronic circuit, a semiconductor memory device, a ROM, a flash memory, an erasable ROM (EROM), a floppy diskette, a CD-ROM, an optical disk, a hard disk, a fiber optic medium, a radio frequency (RF) link, etc. The computer data signal may include any signal that can propagate over a transmission medium such as electronic network channels, optical fibers, air, electromagnetic, RF links, and the like. The code segments may be downloaded via computer networks such as the Internet, an intranet, a LAN, a WAN, and the like.

As discussed earlier, upon completion of the software and/or graphical user interface development process, the corresponding code may be stored in the database 24 or on a machine-readable medium. The code may then made available to users such as those located at user computer 1-N, i.e., computers 40₁-40_{N} through service center 12 or by means of the machine-readable medium. If the software or graphical user interface is presented via the machine-readable medium, the computers 40₁-40_{N} may not necessarily be linked to the remote network for purposes of using the invention.

In the context of a practical system, an end user views the navigation interface display by accessing service center 12. In particular, after a user computer system 40 establishes two-way communications with the service center 12, the user is invited to select use of the programs developed and stored at the service center 12. In one embodiment, the user may be able to locate and identify streaming media using the graphical user interface of the invention, or to tune to one or more stations, or to download one or more programs as provided by the invention. Such downloading may occur either upon payment of a predetermined amount or upon signing on as a member of a program. The user may also be invited to make transactions such as purchasing of additional services or goods. In making payments or purchases, verification of the user's identity or credit may be provided via verification entity 60.

A web portal that incorporates techniques of the present invention is preferably used by listeners of live streaming audio (Internet Radio) and/or end users seeking any streaming media content. Such a web portal may achieve the following objectives easily and quickly:

Present a user interface that displays a large number of available stations efficiently, but doesn't overwhelm the user with information;

Quickly find Internet Radio Broadcasters (“stations”) by genre;

Identify stations broadcasting at a suitable bandwidth, i.e., fast enough to meet the user's minimum quality expectation, but not faster than the respective Internet connection will support;

Suggest stations which might have “similar” programming to stations that are currently selected by end users;

Encompass any number of available broadcast technologies, e.g., WMA, MP3, Real Audio, QuickTime, and any future media; and

Remember a user's preferences, favorites, and history.

This specification describes the functional specifications of an exemplary portal and navigation display interface, including a description of its core features.

Web Site

A web site according to the present invention can be accessed with a standard web browser by entering a suitable target URL, e.g., www.SonicIsland.com or www.SonicIsle.com. In the following description and for the purposes of discussion, reference will be made to SonicIsland.com as an exemplary web site, service center, or administrator of the streaming media portal system. It is understood that any other web site or corresponding URL may be used. In one embodiment, the navigation interface display, which is rendered on the end user's presentation device, is preferably divided into different functional areas which can be selected via a “tabbed” or otherwise selectable interface. A number of exemplary tabs are:

Map Tab;

Yellow Pages Tab;

World Tab;

Search Tab; and

Preferences Tab.

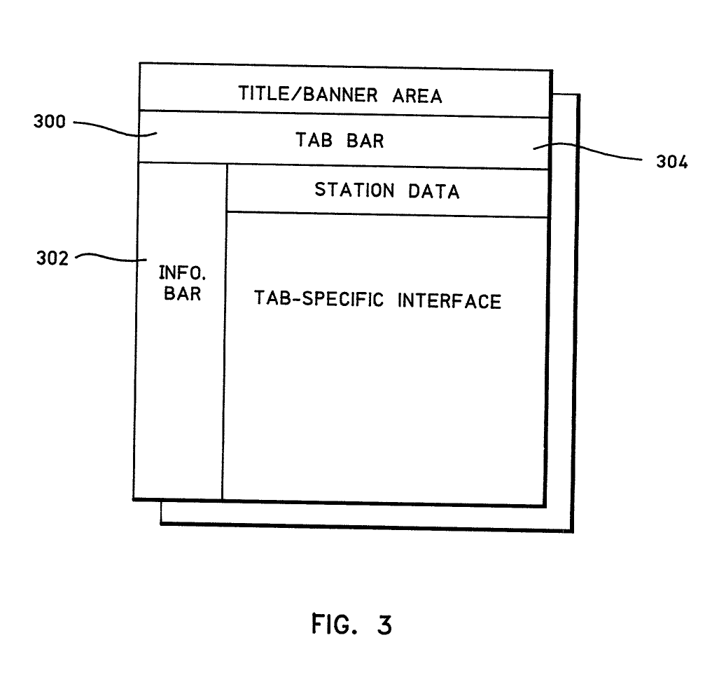

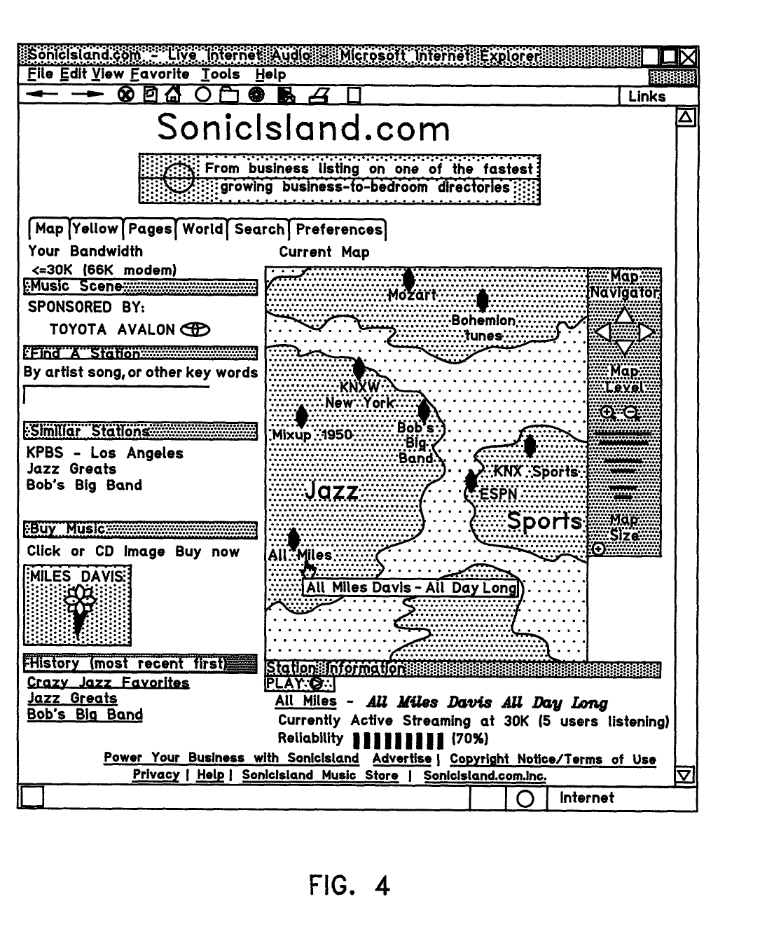

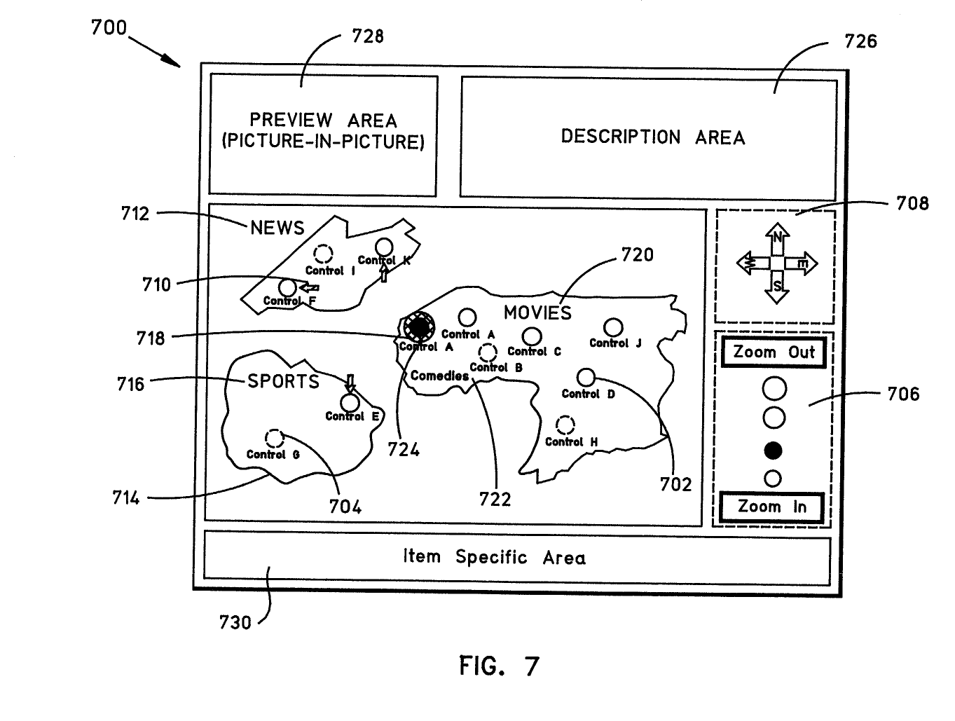

FIG. 3 depicts a tab bar area 300 in which such tabs may be rendered. The tab bar area 300 is also shown in FIG. 4, along with these specific tab elements. The first four tabs may represent different “views” into the world of Internet Radio Stations or into any appropriate environment associated with a number of streaming media sources. As shown in FIG. 3, these tabs may have common interfaces on the left hand side (e.g., the Information Bar 302) and the top (e.g., the Station Data element 304). The exemplary layout can be see graphically in FIG. 3. In addition, one example of the graphical user interface of FIG. 3 is shown in FIG. 4, and FIG. 7 is a schematic representation of a sample navigation map 700 that may be rendered for use by an end user.

Map Tab

The Map Tab shows a number of available stations using a graphical “map.” An exemplary map 700 is shown in FIG. 7. The map preferably features a mythical group of islands, continents, seas, and possibly other features, each with a set of map items or control points representing available broadcasters. The map 700 may include any number of active map items 702 (which represent content, stations, or channels that are accessible from the currently rendered map) and any number of inactive map items 704 (which represent content, stations, or channels that are not accessible from the currently rendered map).

Each region on the map is preferably labeled to represent a different genre or category, with different map items and/or broadcaster identifiers located within the appropriate region. Subsets of a genre may be represented by logical sub-regions within a given region. For example, one massive island may be called “Talk Land,” and represent talk radio stations. One portion of the island can be dedicated to sports talk, another may focus on Christian talk, and so on. FIG. 7 shows a “News” region 710 identified by a “News” label 712, a “Sports” region 714 identified by a “Sports” label 716, and a “Movies” region 718 identified by a “Movies” label 720. FIG. 7 also shows a “Comedies” sub-region identified by a “Comedies” label 722.

The map may be displayed with rolling hills, water, forests, deserts, and other terrain. Stations are preferably displayed as map items, icons, or graphic elements. The display can be dynamic in nature to reflect what is happening at the moment. The appearance of the map items can change based on advertised bandwidth, whether the stations are currently broadcasting, whether they are full, whether they are currently active or inactive, whether they are marked as “favorites”, and/or other criteria. For example, the appearance of an active map item (e.g., map item 702) preferably differs from the appearance of an inactive map item (e.g., map item 704). In addition, the appearance of a selected map item (e.g., map item 724) may be further distinguishable. The user can zoom-in and zoom-out (by using, e.g., a zoom tool 706 rendered on the navigation interface display), scroll to other portions of the map (by using, e.g., a panning tool 708 rendered on the navigation interface display), click on a station icon to find out more information about the station, and perform other functions. The display is preferably “live” in that information displayed for the station will change dynamically as the station's status changes. For example, if a station becomes “full”, the map item appearance may change immediately to reflect the new status.

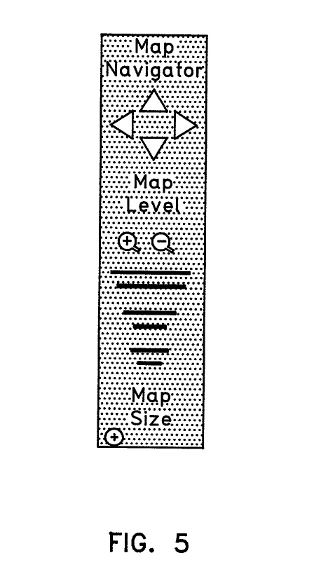

The navigation interface for the map may be rendered in the form of a Navigation Bar (see FIG. 5) attached to the right-hand side of the navigation map. It preferably includes a number of arrows that allow the users to scroll the map in any direction, zoom controls to change the level of magnification (e.g., 3 or 4 different zoom levels), and map size controls (for the user to change the size of the displayed map).

At the minimum magnification level, the whole virtual world may be displayed with only the high-level genres and only a few stations visible as active map items. As the user zooms in, more sub-genres may appear with more stations visible as active map items.

When the user clicks on a station icon or active map item, the icon may be suitably highlighted and the station's information can be displayed in the Station Data element 304. In the alternate embodiment shown in FIG. 7, information related to the specific content selected by the end user may be displayed in a content description area 726, a preview of clip of the selected content may be displayed in a preview window 728, and information related to the selected station or channel (e.g., programming data, schedules, advertising, or the like) may be displayed in an item-specific area 730.

Yellow Pages Tab

The Yellow Pages tab may be used to display the radio stations and/or other content providers in a hierarchical format organized in any fashion, e.g., by genre. Like YAHOO!'s interface, the user may be permitted to “drill down” to the genres in which they are interested. Each station's listing can contain the name of the station, a URL, the transmission bandwidth, the currently playing song broadcast technology, and the station reliability. Each station may also have an associated “Map” button which, when clicked, will immediately display the Map Tab with the selected station's map item displayed in the center of the map. Selecting a station will display the station's information in the Station Data element 304.

World Tab

In the example embodiment, the World Tab displays real world radio stations (e.g., FM and AM stations). Instead of the virtual world displayed in the Map Tab, the World Tab may employ an actual map of the world. In one embodiment, when a user first enters the World Tab, SonicIsland.com will display the United States, since the majority of users will be from the United States and will want to listen to stations based in the United States. In an alternate embodiment, the end user's IP address might be used to determine the default region displayed. Using the same navigation bar displayed on the Map Tab, the user can zoom into a state or region to locate a traditional radio or television station.

When the user clicks on an active map item, the icon will be highlighted and the station's information will be displayed in the Station Data element 304.

Search Tab

The Search Tab preferably displays a standard search engine-like interface. At the top is the search box. The user types desired search criteria and the SonicIsland.com system will automatically search according to any criteria, e.g., by Artist, Station Name, Genre, and/or Song.

The search results can be grouped logically by:

Genre;

Station Name;

Artist;

Song played in the last 24 hours; and/or

Song being played now.

Like the Yellow Pages tab, each station entry may show live information. When a station is selected, the station's information is preferably displayed in the Station Data element 304.

Preferences Tab

In accordance with one practical embodiment, a Preferences Tab will be made available to registered users. This allows end users to change their filtering criteria and preferences. For example, the user can change any of the following:

Bandwidth Filter. This filter may be used to only display stations broadcasting within a specified range of bit rates. In this respect, the system may also provide selections for common Internet connections (e.g. 33.6 modem, 56K modem, DSL, T1, High Speed, or the like).

Active Only Filter. This filter may be used to only display stations that are currently broadcasting.

Not Full Filter. This filter may be used to only display stations which haven't reached capacity.

Quality Filter. This filter may be used to display stations meeting the SonicIsland.com system quality heuristics.

Only Certified Stations. This filter may be used to only display stations associated with “real network stations”.

Preferred Media Player Filter. Since some stations broadcast using a multiplicity of media streams (e.g. Real Audio and WMA), this filter allows the user to select their preferred streaming media format. Users may also be allowed to exclude some types of streaming media if they do not have a supported player installed on their system. For example, Linux users might want to exclude WMA.

Mailing information. This filter allows end users to select whether they want to receive the opt-in mailings sent by SonicIsland.com.

Station Area

This is an area that may be positioned below the tabs on the Map Tab, List Tab, World Tab, and Search Tab. It preferably contains live information about the currently selected station, including:

Station Name.

URL. The end user may click on the URL to jump directly to the station's WEB site.

Bandwidth, expressed in kbits/sec.

Current song or content. This field can be continuously updated.

Number of users in the selected station. This field can be continuously updated.

Popularity Ratings. These ratings may include rankings such as “X of Y displayed”, and/or “A of B in Genre”.

Broadcast technology. This information may be displayed iconically to represent different content delivery formats, e.g., RealAudio, QuickTime, WMA, or streaming MP3.

Station Reliability. This data can be represented by a “signal strength” graphical bar or other display element.

Play Button. This element will launch the appropriate media player for the end user, thus initiating playback of the selected streaming media file.

SonicIsland.com may allow radio stations to use custom buttons.

Rate Button. This element allows the user to “rate” the station. This feature can be used in combination with actual station listening patterns to judge station popularity. It can also enhance SonicIsland.com's “stickiness”, where users will tend to stay at the SonicIsland.com web site as long as possible.

Add Bookmark Button. This element adds the bookmark for the selected station to the user's browser bookmark or “Favorites” list. Selecting the bookmark will return the user to the exact station and View in SonicIsland.com, so that they can immediately click on the station to play it.

Add to Favorites Button. This element adds the current station to the end user's Favorites list. If the user isn't registered, he/she may be asked to register before this feature is enable.

As discussed herein, there may be different interfaces available, depending on the browser technology used by the user. Given a browser application of sufficiently recent technology (i.e. IE 4+ or NS 4+), the Station Area feature may also be able to check the client-to-station connection in real time.

Information Bar

The Information Bar is configured as a multifunctional area on the left side of the Map, Yellow Pages, World, and Search tabs. In accordance with one example embodiment, the Information Bar includes several panes:

Quick Filters. This filtering allows the user to quickly filter the stations without having to switch to the Preferences Tab.

Similar Stations. This element displays other stations which are “similar” to the currently selected station. Similar stations can be rated based on other SonicIsland.com users behaviors.

Search. This feature allows the user to search for stations by Artist, Station Name, Genre, and Song. Entering information into this box will immediately switch to the Search Tab.

CD Image. This element may contain an image of a compact disc, showing the currently playing music on the currently selected station. Clicking on the image will transfer the user to a CD purchase web site. In a commercial embodiment, the CD purchase web site will likely be a strategic retail partner of the administrator of the user interface system.

History. This element may list a number of recent stations (e.g., the last 10) that the user has listened to. Clicking on a station in the history will show it immediately in the current view. Clicking on the play button will activate that station. This element may also include “forward” and “back” buttons that allow the user to navigate throughout the history.

Favorites. This element may contain a listing of the user's favorites. Clicking on a station name will display it immediately in the map. Clicking on the play button will activate that station.

Additional Features

User Registration

Users will be encouraged to register with SonicIsland.com; registering will allow them to use some of the more advanced SonicIsland.com features. This will allow SonicIsland.com to track usage by user name. There may be some optional demographic information which the user will be asked to enter when they register, including age, sex, and income. There may also be a checkbox asking them if they want to “opt-in” to SonicIsland.com mailings. When users re-enter SonicIsland.com they need not be required to reenter their user name; their “cookie” will be used to look up this information in the system database.

Certain features of the SonicIsland.com system may only be available to registered users. This includes Favorites, weekly mailings, automatic entry into contests, and other preferred features.

State Saving

The SonicIsland.com system is capable of storing the user's current Tab, map location, zoom level, history, preferences, and other parameters. Using this information, it may automatically restore the state when the user returns to SonicIsland.com. This feature can be managed via cookies. If the user's browser does not accept cookies, then the state information can be saved via the user ID.

Alternate Entry Points

In addition to the standard www.SonicIsland.com entry point, there may be a number of alternate entry points which can be used (and the user can bookmark). These include:

Map.SonicIsland.com—this can point to the Map Tab display.

Search.SonicIsland.com—this can point to the Search Tab display.

World.SonicIsland.com—this can point to the World Tab display.

Yp.SonicIsland.com—this can point to the Yellow Pages Tab display.

Any number of other entry points may be utilized to automatically display maps at pre-defined locations, with stations pre-selected. For example, broadcasters can add this type of link to their web sites.

Favorites

When users find a station that they like, they can automatically memorize the station by clicking “Save Favorite”. This will add the selected station to their list of favorite stations. In one commercial embodiment, users will be required to register to use this feature.

History

Regarding this feature, when a user listens to a station, the station will be added to the user's History. A number of recent stations, e.g., the last 10 stations, will be displayed in the Information Bar.

Advertising

The Portal may also have appropriate areas for advertising. For example, the web site may reserve a space for a standard sized (468×80 pixel) banner across the top of the display. SonicIsland.com can also offer “in map” advertising space.

Station Interface

Stations administrators may be permitted to have their own entry point into the SonicIsland.com site. For example, registered radio stations will be able to change their title, URL, chat, genre, map location, etc. The interface will support manual and automatic updates of this information.

Suggest Station Interface

Using this feature, end users can suggest stations to SonicIsland.com through a suitable interface and register the suggested station as a preferred station.

Instant Messaging Integration

In one practical embodiment, the SonicIsland.com site will feature instant message notification. Using standard instant messaging protocols used by AIM, ICQ, iCAST, or others, users can be notified when certain stations become available, when particular songs are played, etc.

Data Mining Interface

The system administrators may collect and/or organize statistical survey or user preference data. In this respect, subscribers to SonicIsland.com's data mining service will be able to remotely query the database and retrieve up-to-the-minute station, song, and artist information. This would likely be implemented through an XML interface.

Implementation Details of One Embodiment

Server Architecture

In the preferred embodiment, the SonicIsland.com site will be driven by a set of servers co-located at the appropriate site or sites. In one embodiment, an n-tiered server architecture may be used. The application may be split into three layers. These layers are:

1) Presentation layer;

2) Application logic; and

3) Data.

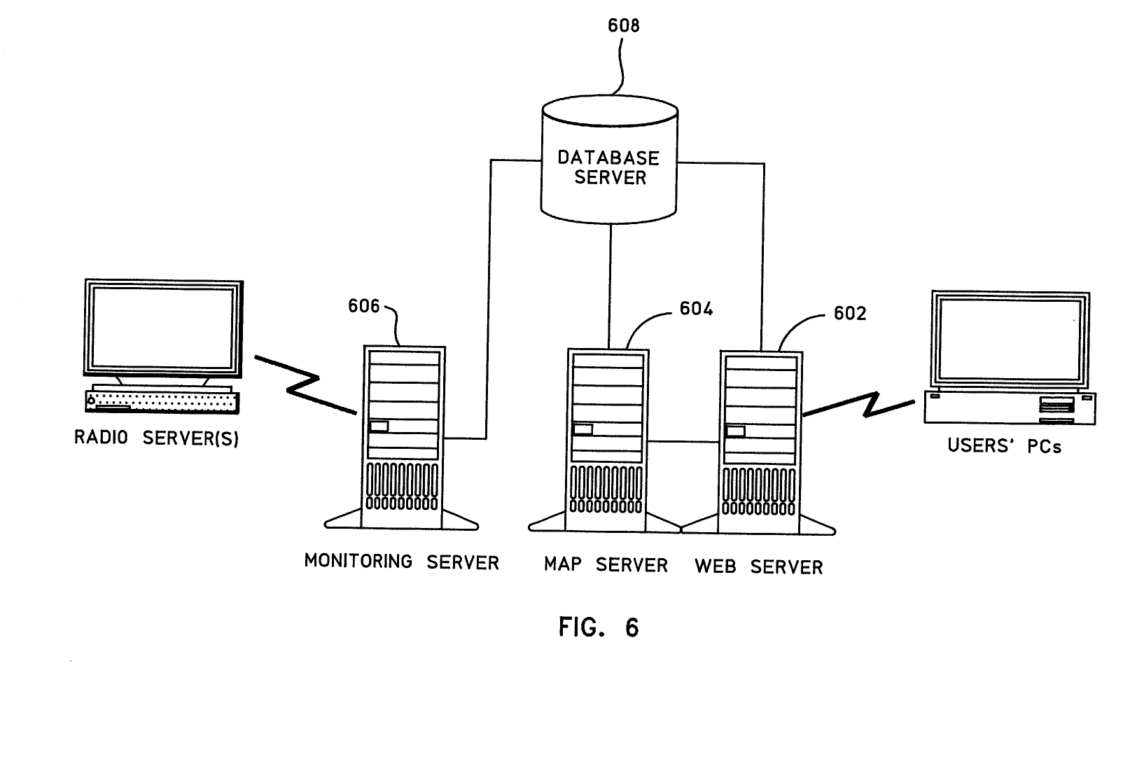

One embodiment of the architecture is shown in FIG. 1. An alternate embodiment of the architecture is shown in FIG. 6.

In one practical embodiment, all of the servers that support and maintain the SonicIsland.com site operate on an industry standard platform (Intel or Sparc-based) with the Linux or Windows NT operating system. Each server module may run on one or more physical computers. The server modules and their functions are listed below:

Web Server (Presentation Layer)

In one current embodiment, the presentation layer employs an industry standard web server 602 (e.g., APACHE) which will handle the user interface. The front-end will be coded using industry-standard technologies such as HTML, XML, Java, and ActiveX. In the preferred embodiment, the web server 602 has a direct connection to the Internet.

The web server 602 preferably handles both the end-user interface and the station interface.

Map Server (Application Logic)

The map server 604 dynamically generates maps requested by end users. Given a location in either SonicIsland.com's virtual world (Map Tab) or the world map (World Tab), the map server 604 generates a graphical navigation map (e.g., map 700) to be displayed by the web server 602. As described herein, the map server 604 can render the map data in several different formats.

Monitoring Server (Application Layer)

The monitoring server 606 sends requests to known stations at predefined intervals to determine their status, including the currently playing song, number of available listener slots, etc. Whenever a station's status changes (including current song, number of users, etc.), the monitoring server 606 will update the station's entry in the Database Server 608. In the preferred embodiment, the monitoring server 606 has a direct connection to the Internet. The monitoring server 606 may be configured as a custom application.

Database Server (Data)

The database server 608 is preferably configured as an industry standard database such as Oracle, DB2, or SQL server, which will be scalable as the system requirements increase. The database 608 preferably stores all of the data utilized by the SonicIsland.com site and the data utilized by the navigation display system.

The data stored by the database 608 may include any of the following tables:

Station tables. These tables include any relevant station information, including Name, URL, Map location, physical location (if applicable), WEB address, current song, uptime history, current status, network affiliation.

Song, Artist, and Album tables. These tables contain known songs, albums, and artists, and music purchase information (e.g., the appropriate URL to launch if a user wants to purchase this CD).

User table. This table identifies the SonicIsland.com users (whether registered or not) and includes their cookies, user IDs, e-mail addresses, preferences, etc.

User Favorites table. This table stores the users' favorites.

User History table. This table maps Users to Stations and stores stations that users have accessed or content presented to the users.

Station Song History Table. This table maintains a historical record of the content or files played by each station over a specified period of time.

The actual tables, indices, predefined queries, and other parameters of the database may be defined at implementation time.

Data mining (queries) can deliver interesting information from the database, including:

Given Station X, what other stations do users like to hear?

What are the most popular stations in a given genre?

What stations play artist X most often (ranked by popularity)?

What are the most reliable stations?

What stations are most often shown in user's favorites?

Map Interface

The map interface is a unique display paradigm used in the Map and World Tabs. The design goal is to allow the user quick navigation to stations by balancing display space with the large number of possible stations. Because different users use different technologies to connect to the web, e.g., different browsers, different levels of security, different connection speeds, and the like, there really isn't a “one interface suits all” approach. Therefore, SonicIsland.com's map interface is configured as a hierarchy of technologies, which will be enabled based on the capabilities and desires of the end user. The system may automatically detect the user's browser capabilities and “gracefully degrade” to give the user the best possible experience.

Basic Interface (AKA Least Common Denominator Interface) This interface is suitable for users who don't like, don't want to use, or whose browsers are incompatible with Java. The map will not be live and information displayed will only be updated when the user clicks “Refresh”. This interface can be implemented using a combination of standard HTML and basic graphics (GIF & JPEG). Navigating throughout the Map will reload the appropriate GIF file from the Web Server.

Advanced Interface This interface may use advanced technologies such as Java, DHTML, and Active X to create a “live” interface with station statistics changing on the user's screen in real-time and live icons on the map. This interface may be limited to certain web browser applications, e.g., NS 4+ and IE 4+ browsers (which are approximately 80% of all installed browsers).

ActiveX Interface Users who want an enhanced SonicIsland.com experience can download the ActiveX interface. Since ActiveX components run locally and natively on a user's PC, they can be extremely fast. The ActiveX interface will give the user very rapid map navigation. When the user clicks on the Navigation Bar to scroll, instead of waiting for the new map to download from the SonicIsland.com servers, the map information will display immediately, because the component will cache map data on the user's PC and only download station state information. It can also have tighter integration with Media players.

Both the Advanced Interface and ActiveX interface will be able to test server connections directly from the user's PC. This connection status information can be sent to SonicIsland.com (with the user's permission) to give SonicIsland.com valuable station reliability data.

The ActiveX-based interface can also be the basis for SonicIsland.com's stand-alone (Win32) application. This would be implemented as a simple Win32 wrapper around the ActiveX control.

Commercial Implications

Based on the principles of the invention, revenue may be sought from three major sources: advertising, e-commerce, and data sales. The demographics of target users (they're young, have money, love the Internet, spend their dollars on-line, etc.) make them highly desirable advertising targets. Even as spending on Internet advertising diminishes over time (which may be an inevitable function of virtually infinite space vying for finite dollars), advertisers will naturally become more selective and direct their resources towards audiences with the highest qualified value. Sites with mundane hit rates and marginal customer qualification will be undesirable resource drains, whereas users of the invention are relatively affluent and technology-savvy, and will likely remain the most sought after audience and premium target market, and consequently will retain the highest value to advertisers.

E-commerce revenue can be generated through click-through sales of CDs and related music products. Users of the apparatus and method of the invention will have the capability of immediately buying CDs on-line, whenever they hear an artist they like.

Fees can also be generated by selling data access to users listed in a database. The database will be continuously updated with on-air status, current artist, current song, number of users, and other information culled from a number of known Internet radio broadcasters. This is valuable demographic information that can be sold to media companies, broadcast networks, ratings servers, and others who need real-time broadcast/listener information.

The present invention has been described above with reference to a preferred embodiment. However, those skilled in the art having read this disclosure will recognize that changes and modifications may be made to the preferred embodiment without departing from the scope of the present invention. These and other changes or modifications are intended to be included within the scope of the present invention, as expressed in the following claims.

What is claimed is:

1. A system for displaying a number of interactive navigation maps, said system comprising:
a map server configured to process map data for a navigation map having a number of map items representing content, files, or data available to an end user;
a processor configured to determine a number of display capabilities associated with a presentation device utilized by said end user; and
a plurality of end user display interfaces in communication with said map server, each of said end user display interfaces being configured to process said navigation map in a manner that is responsive to said number of display capabilities;
said processor being further configured to select one of said end user display interfaces for rendering of said navigation map.

2. A system according to claim 1, wherein said processor is further configured to format said navigation map for compatibility with said end user display interface.

3. A system according to claim 1, further comprising a database in communication with said map server, said database containing navigation map data corresponding to said navigation map.

4. A system according to claim 1, further comprising a monitoring server configured to determine the current status of a number of streaming media stations that provide streaming media content represented by said number of map items.

5. A system according to claim 4, further comprising a database in communication with said monitoring server, wherein said monitoring server is further configured to update said map data in response to a status change of any of said number of streaming media stations.

6. A system according to claim 1, wherein said end user display interfaces are associated with at least one web server in communication with said map server.

7. A system according to claim 1, further comprising a plurality of presentation layers in communication with said map server, each of said presentation layers being configured to transform said map data into displayable map data formatted in accordance with a number of display capabilities of a respective end user presentation device.

8. A system according to claim 1, wherein:
said map items represent streaming media content; and
said presentation device is compatible with at least one streaming media player format.

9. A method for providing an interactive navigation display to an end user comprising:
generating a navigation map for display to an end user, said navigation map comprising a number of map items representing content, files, or data available to said end user;
determining a number of display capabilities associated with a presentation device utilized by said end user; and
selecting an end user display interface to process said navigation map, said selecting step being responsive to said number of display capabilities.

10. A method according to claim 9, further comprising the step of transmitting a streaming media file to said end user in response to a map item selection by said end user.

11. A method according to claim 9, further comprising the step of formatting said navigation map for compatibility with said end user display interface.

12. A method according to claim 9, further comprising the step of retrieving navigation map data from a database, said navigation map data corresponding to said navigation map.

13. A method according to claim 12, further comprising the steps of:
determining the current status of a number of streaming media stations that provide streaming media content represented by said number of map items; and
updating said navigation map data in response to a status change of any of said number of streaming media stations.

14. A method according to claim 12, wherein said navigation map data comprises streaming media station information.

15. A method according to claim 12, wherein said navigation map data comprises streaming media content information.

16. A method for accessing a streaming media file comprising:
accessing a target web site with an end user presentation device;
interacting with a navigation map displayed on a web page associated with said web site, said navigation map comprising a graphic region representing a programming genre and a number of map items located on said graphic region, each of said map items representing streaming media content related to said programming genre;
selecting an active map item rendered on said navigation map; and
playing, at said end user presentation device, a streaming media file corresponding to said active map item.

17. An interactive navigation interface for providing access to streaming media files, said interface comprising:
a navigation map comprising a graphic region representing a programming genre;
a first number of map items displayed in a first area of said graphic region, each of said first number of map items representing a different streaming media file related to a first sub-genre of said programming genre; and
a second number of map items displayed in a second area of said graphic region, each of said second number of map items representing a different streaming media file related to a second sub-genre of said programming genre.

18. An interface according to claim 17, further comprising:
a second graphic region rendered with said navigation map, said second graphic region representing a second programming genre; and
a third number of map items displayed in said second graphic region, each of said third number of map items representing a different streaming media file related to said second programming genre.

19. An interactive navigation interface for streaming media access, said interface comprising:
a navigation map comprising a graphic region representing a programming genre;
a number of map items associated with said graphic region, each of said map items representing streaming media content related to said programming genre; and
a station data element containing information related to a currently selected map item.

20. An interactive navigation interface according to claim 19, wherein said station data element contains a bandwidth indicator that represents the effective transmission bandwidth of streaming media content accessed via said currently selected map item.

21. An interactive navigation interface according to claim 19, wherein said station data element contains a broadcast technology indicator associated with a number of available content delivery formats for streaming media content accessed via said currently selected map item.

22. An interactive navigation interface according to claim 19, wherein said station data element contains a quality of service indicator associated with streaming media content accessed via said currently selected map item.

23. An interactive navigation interface according to claim 19, wherein said navigation map is rendered in connection with a map display window accessible from a web page.

24. An interactive navigation interface accor ding to claim 23, further comprising a directory listing window accessible from said web page, said directory listing window containing information related to a number of content sources or content providers.

25. An interactive navigation interface according to claim 23, further comprising a second navigation map rendered in connection with a world map display window accessible from said web page, said second navigation map comprising a number of map items representing traditional radio or television stations.

26. An interactive navigation interface according to claim 23, further comprising a search window accessible from said web page, said search window facilitating end user searching for streaming media content according to specified criteria.

27. An interactive navigation interface according to claim 23, further comprising a preferences window accessible from said web page, said preferences window enabling end user filtering of streaming media content according to specified criteria.

28. An interactive navigation interface according to claim 19, further comprising an information bar comprising a number of panes associated with different features related to end user interaction with said interface.
